(19) United States
(12) Patent Application Publication
(10) Pub. No.: US 2011/0154262 A1
(43) Pub. Date: Jun. 23, 2011

(54) METHOD AND DEVICE FOR ANTICIPATING APPLICATION SWITCH

(75) Inventors: HSIN-CHANG LAI, Tu-Cheng (TW); JIUN-RU HOU, Tu-Cheng (TW); LIU-WEI WU, Tu-Cheng (TW)

(73) Assignee: CHI MEI COMMUNICATION SYSTEMS, INC., Tu-Cheng City (TW)

(21) Appl. No.: 12/831,275

(22) Filed: Jul. 7, 2010

(30) Foreign Application Priority Data
Dec. 17, 2009 (CN) 200910311689.9

(51) Int. Cl. G06F 3/048

(52) U.S. Cl. 715/825

(57) ABSTRACT

A device in conjunction with a correlation matrix anticipates combinations of applications of the device switching from one to another on a display of the device. The device utilizes an anticipation system to determine which application is active, generate a switch anticipation list from the correlation matrix according to the active application, create a selection menu from the switch anticipation list, and send the selection menu to the display. The device updates the correlation matrix with a predetermined correlation function.

### BACKGROUND

1. Technical Field

Embodiments of the present disclosure relate to user interfaces, and more particularly to a method and device for anticipating application switch.

2. Description of Related Art

Portable electronic devices, such as mobile phones, personal digital assistants (PDAs), and digital cameras are becoming increasingly compact. However, small display areas of these electronic devices can handicap user interfaces and input controls thereof may be less convenient than in personal computers having a larger display/input area. For example, users are accustomed to previewing photos immediately following image capture on a mobile phone. In such an occasion, the users need to quit the camera application, return to the main menu and go through several layers of menus to find the right photo.

### BRIEF DESCRIPTION OF THE DRAWINGS

FIG. 1 is a block diagram of one embodiment of a device for anticipating application switch.

FIG. 2 is an exemplary embodiment of a correlation matrix.

FIG. 3 is a flowchart illustrating one embodiment of a method for anticipating application switch.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be integrated in firmware, such as an EPROM. It will be appreciated that module may comprise connected logic units, such as gates and flip-flops, and may comprise programmable units, such as programmable gate arrays or processors. The units described herein may be implemented as software and/or hardware unit and may be stored in any type of computer-readable medium or other computer storage device.

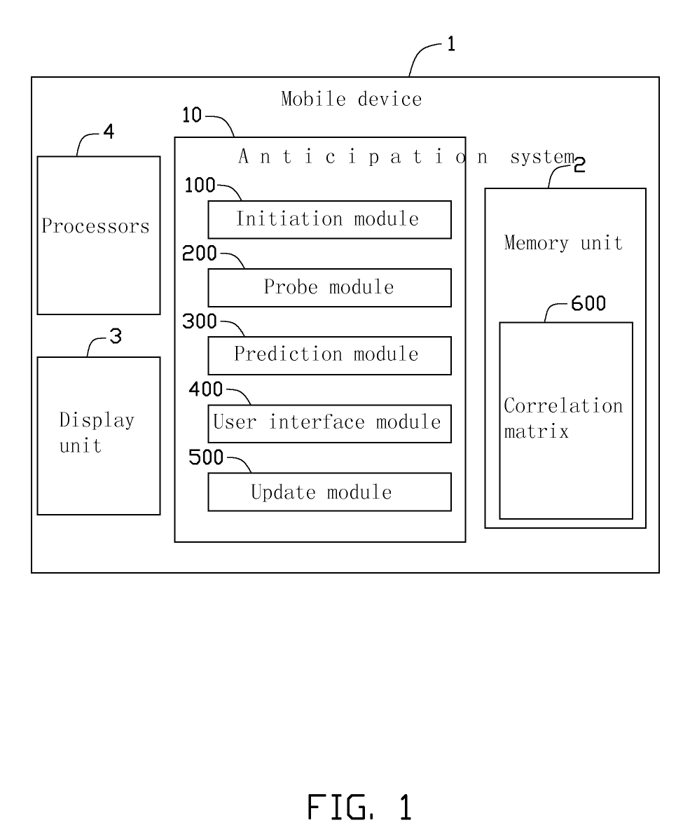

FIG. 1 is a block diagram of a mobile device 1 comprising a memory unit 2 storing a correlation matrix 600, a display unit 3 and an anticipation system 10. As used herein, “application switching” is used to define switching from one application to another application on a display of an electronic device. Application switching may run one or more applications concurrently on the electronic device. The mobile device 1 can be used in conjunction with the correlation matrix 600 to predict application switching combinations of applications of the mobile device 1. Depending on the embodiment, the mobile device 1 can be a mobile phone, or a camera, for example.

The system 10 includes an initiation module 100 to initiate the system 10, a identification module 200 to determine which application of the mobile device 1 is active, an anticipation module 300 to generate a switch anticipation list from the correlation matrix 600 according to the active application, an user interface module 400 to create a selection menu from the switch anticipation list and display the menu on the display module 3 and an update module 500 to update the correlation matrix 600. One or more computerized codes of the modules are stored in the memory unit 2 and are executed by one or more processors 4.

It should be understood that the correlation matrix 600 is a data matrix comprising a list of applications of the mobile device 1 that are arranged in rows and columns of the correlation matrix 600. Applications in the rows and columns of the correlation matrix 600 can be sorted in order to find an active application of the mobile device 1. Further details of the correlation matrix 600 will be described below.

In one embodiment, the initiation module 100 can be initiated when a preset key on the mobile device 1 is pressed. The initiation module 100 is operable to trigger the identification module 200 when the preset key is pressed. The identification module 200 is operable to determine which application of the device 1 is active when the preset key is pressed and inform the anticipation module 300 of the active application. The anticipation module 300 is operable to consult the correlation matrix 600 for a column of the correlation matrix 600 having the active application and retrieve the column. The preset key may be a key on a physical or virtual keyboard of mobile device 1. Alternatively, the preset key can be a button of the mobile device 1. The anticipation module 300 is operable to sort the column from highest to lowest using a quick-sort algorithm and adapt the top three entries of the sorted column into the switch anticipation list. The anticipation module 300 is operable to send the switch anticipation list to the user interface module 400. The user interface module 400 is operable to use the received list to create a selection menu and display the menu on the display unit 3. Applications are switched by selection of a desired application from the selection menu. The user interface module 400 is operable to feed back the selection to the update module 500, which in turn updates the correlation matrix 600 with a predetermined correlation function according to the feedback.

In the embodiment, the predetermined correlation function is defined as

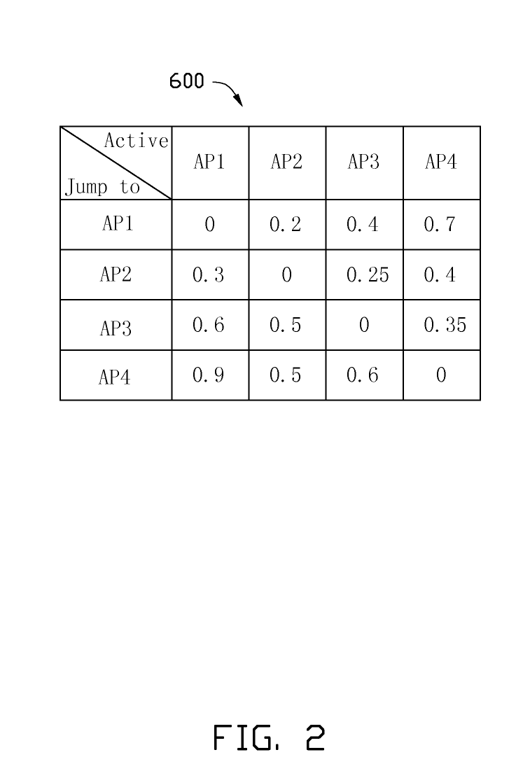

C₁=C₀+α×(γ+γ×C₀−C₀),

where C₁ is the updated correlation, C₀ is the original correlation, α is a feedback coefficient, and γ is a reinforcement coefficient to control degree of reinforcement. In the embodiment, the coefficient γ is set to 0.1. The coefficient α is set to 1 for positive feedback if the application corresponding to the entry to switch is selected. Otherwise, the coefficient α is set to −1 for negative feedback. For example, in FIG. 2, if AP3 is active, the entries in the fourth column need to be updated. If AP2 is selected, the coefficient α is set to −1 for the second, fourth and fifth entries and to 1 for the third entry which corresponds to the selection. As the result, the fourth column is updated to (AP3, −0.06, 0.575, −0.1, −0.04).

FIG. 2 is an exemplary embodiment of a correlation matrix. The first row represents applications to switch from. The first column represents application to switch to. The other entries are correlations for the possibility of application switch. For example, the number 0.2 in the second row, and third column means the possibility of AP2 switching to AP1 is calculated with the predetermined correlation function as a quantized number which is 0.2. The higher the value is, the more likely the user selects the application corresponding to the entry to switch to and vice versa.

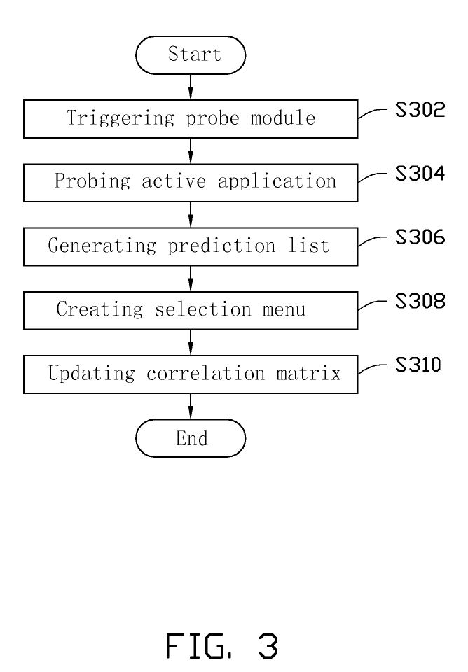

FIG. 3 is a flowchart of one embodiment of a method for switching application of the mobile device 1. Depending on the embodiments, additional blocks may be added, others removed, and the ordering of the blocks may be changed.

In block S302, the initiation module 100 triggers the identification module 200 to determine which application of the mobile device 1 is active. In block S302, the identification module 200 determines which application of the mobile device 1 is active and informs the anticipation module 300 of the active application.

In block S306, the anticipation module 300 consults the correlation matrix 600 for a column of the correlation matrix 600 having the active application and retrieves the column. The anticipation module 300 sorts the column from highest to lowest using a quick-sort algorithm and adapts the top three entries of the sorted column into the switch anticipation list. The anticipation module 300 sends the switch anticipation list to the user interface module 400.

In block S308, the user interface module 400 uses the received list to create a selection menu and display the menu on the display unit 3. Applications are switched by selection of a desired application from the selection menu. The user interface module 400 feeds the selection back to the update module 500. In block S310, the update module 500 updates the correlation matrix 600 with the predetermined correlation function according to the feedback.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display unit;
a memory system;
one or more processors; and
one or more programs stored in the memory system configured to be executed by the one or more processors, the one or more programs comprising:
an initiation module to trigger an identification module to determine which application of the electronic device is active;
an anticipation module to generate a switch anticipation list from a correlation matrix stored in the memory system, according to the active application;
a user interface module to create a selection menu from the switch anticipation list and display the selection menu on the display unit; and
an update module to update the correlation matrix with a predetermined correlation function according to feedback from the user interface module.

2. The device as claimed in claim 1, wherein the predetermined correlation function includes a coefficient to control either positive or negative feedback.

3. The device as claimed in claim 2, wherein the predetermined correlation function includes a coefficient to control degree of reinforcement.

4. The device as claimed in claim 3, wherein the predetermined correlation function includes a original correlation as an argument.

5. The device as claimed in claim 1, wherein the anticipation module consults the correlation matrix for a column having the active application, sorts the column and adapts the top three entries of the sorted column into the switch anticipation list.

6. A computerized method of an electronic device, comprising:
triggering an identification module of the electronic device to determine which application of the electronic device is active;
consulting a correlation matrix for a column of the correlation matrix having the active application, the correlation matrix being stored in a memory system of the electronic device;
sorting the column from highest to lowest;
adapting the top three entries of the sorted column into a switch anticipation list;
creating a selection menu from the switch anticipation list;
displaying the selection menu on a display unit; and
updating the correlation matrix with a predetermined correlation function according to feedback.

7. The method as claimed in claim 6, wherein the predetermined correlation function includes a coefficient to control either positive or negative feedback.

8. The method as claimed in claim 7, wherein the predetermined correlation function includes a coefficient to control degrees of the feedback.

9. The method as claimed in claim 8, wherein the predetermined correlation function includes the current correlation as an argument.

10. A computer readable storage medium having stored therein instructions, that when executed by an electronic device with a display and memory unit, cause the device to:
trigger an identification module of the electronic device to determine which application of the electronic device is active;
consult a correlation matrix for a column having the active application, the correlation matrix being stored in a memory system of the electronic device;
sort the column from highest to lowest;
adapt the top three entries of the sorted column into a switch anticipation list;
create a selection menu from the switch anticipation list;
display the selection menu on the display unit; and
update the correlation matrix with a predetermined correlation function according to feedback.

11. The computer readable storage medium as claimed in claim 10, wherein the predetermined correlation function includes a coefficient to control either positive or negative feedback.

12. The computer readable storage medium as claimed in claim 11, wherein the predetermined correlation function includes a coefficient to control degrees of the feedback.

13. The computer readable storage medium as claimed in claim 12, wherein the predetermined correlation function includes the current correlation as an argument.
